(19) United States
(12) Patent Application Publication
(10) Pub. No.: US 2014/0285799 A1
(43) Pub. Date: Sep. 25, 2014

(54) SPECTROSCOPIC CAMERA AND ALIGNMENT ADJUSTMENT METHOD

(71) Applicant: Seiko Epson Corporation, Tokyo (JP)

(72) Inventor: Kazunori SAKURAI, Chino (JP)

(73) Assignee: Seiko Epson Corporation, Tokyo (JP)

(21) Appl. No.: 14/223,009

(22) Filed: Mar. 24, 2014

(30) Foreign Application Priority Data
Mar. 25, 2013 (JP) 2013-061547

(51) Int. Cl. G01J 3/28

(52) U.S. Cl. CPC G01J 3/2823
USPC 356/302

(57) ABSTRACT

A spectroscopic camera includes a light incident section provided with an incident angle limiter and first alignment marks, a wavelength tunable interference filter provided with second alignment marks, and a circuit substrate provided with an imaging device and third alignment marks. The amount of deviation of a mechanical central axis of each of the components from an ideal central axis thereof and the angle of rotation indicating the direction of the deviation are measured, and the positions of the first alignment marks and the second alignment marks relative to each other and the positions of the second alignment marks and the third alignment marks relative to each other are so adjusted that the ideal central axes coincide with one another.

### BACKGROUND

1. Technical Field

The present invention relates to a spectroscopic camera and an alignment adjustment method.

2. Related Art

There is a known spectroscopic camera that captures a spectroscopic image of an imaging target object (see JP-A-2002-277758, for example).

The spectroscopic camera described in JP-A-2002-277758 causes light incident through a lens unit to be incident on a CCD (charge coupled device) for image capturing. The lens unit includes an objective lens, an image formation lens, and a wavelength tunable interference filter disposed between the lenses. The dimension of the gap between reflection films of the wavelength tunable interference filter is then changed by using an actuator for selection of the wavelength of light that the interference filter transmits, and a spectroscopic image formed by the light of the selected wavelength is captured with the CCD.

When a spectroscopic device, such as a wavelength tunable interference filter, is used to select light of a predetermined target wavelength out of incident light and transmit the selected light, it is difficult for the spectroscopic device to transmit only light of the exact target wavelength, and the spectroscopic device in practice transmits light of a predetermined band including the target wavelength as a measurement central wavelength. In the spectroscopic device, an ideal central axis along which light of the target wavelength (measurement central wavelength) passes differs from an actual mechanical central axis of the spectroscopic device in some cases.

Further, when a spectroscopic device to be used requires incident light to be incident thereon at right angles, as in the case of a wavelength tunable interference filter, it is preferable to provide, for example, a telecentric optical system, an LCF (light control film), or any other incident angle limiter that limits the angle of incidence. In such an incident angle limiter, the mechanical central axis of the incident angle limiter also differs from an ideal central axis along which incident light can be limited to light having a desired angle in some cases because an in-plane variation in the incident angle limiter causes incident angle limiting characteristics thereof (specific angle to which angle of incidence can be limited, for example) to vary in some cases.

On the other hand, the spectroscopic camera described in JP-A-2002-277758 is assembled by performing alignment adjustment in which the mechanical central axis of the incident angle limiter, the mechanical central axis of the CCD or any other imaging device, and the mechanical central axis of the spectroscopic device are brought into coincidence with one another. When in each of the incident angle limiter and the spectroscopic device, the mechanical central axis deviates from the ideal central axis as described above, however, the spectroscopic camera cannot undesirably acquire a high-precision spectroscopic image.

### SUMMARY

An advantage of some aspects of the invention is to provide a spectroscopic camera in which ideal central axes of an incident angle limiter, a spectroscopic device, and an imaging device coincide with one another and also to provide an alignment adjustment method.

An aspect of the invention is directed to a spectroscopic camera including a spectroscopic device that selects light of a predetermined wavelength from incident light and transmits the selected light and an incident angle limiter that limits the angle of incidence of the incident light incident on the spectroscopic device to a value smaller than or equal to a predetermined angle. The incident angle limiter has a first alignment mark indicating a mechanical central axis of the incident angle limiter, and the spectroscopic device has a second alignment mark indicating a mechanical central axis of the spectroscopic device. An axis shifted from the mechanical central axis of the incident angle limiter not only by the amount of deviation of the mechanical central axis of the incident angle limiter from a first ideal central axis passing through a position where the angle of incidence of the incident light is limited to a predetermined ideal angle in the incident angle limiter but also by the angle of rotation indicating the direction of the deviation coincides with an axis shifted from the mechanical central axis of the spectroscopic device not only by the amount of deviation of the mechanical central axis of the spectroscopic device from a second ideal central axis passing through a position where light of a wavelength at the center of a transmission wavelength region in the spectroscopic device is transmitted but also by the angle of rotation indicating the direction of the deviation.

In the aspect of the invention, the mechanical central axis of the incident angle limiter is an imaginary axis passing through the center of a light passage area in a plan view in which the incident angle limiter is viewed in the light incident direction. Similarly, the mechanical central axis of the spectroscopic device is an imaginary axis passing through the center of a spectroscopic area where desired light is separated from the incident light in a plan view in which the spectroscopic device is viewed in the light incident direction.

In the aspect of the invention, the amount of deviation of the mechanical central axis of the incident angle limiter from the first ideal central axis and the angle of rotation indicating the direction of the deviation are measured as a first adjustment amount, and the amount of deviation of the mechanical central axis of the spectroscopic device from the second ideal central axis and the angle of rotation indicating the direction of the deviation are measured as a second adjustment amount.

When the first alignment mark and the second alignment mark are brought into coincidence with each other, the mechanical central axis of the incident angle limiter coincides with the mechanical central axis of the spectroscopic device in an ideal case. In contrast, in the aspect of the invention, an axis shifted from the first alignment mark by the amount of deviation and the angle of rotation indicating the direction of the deviation that form the first adjustment amount and an axis shifted from the second alignment mark by the amount of deviation and the angle of rotation indicating the direction of the deviation that form the second adjustment amount are brought into coincidence with each other for the alignment adjustment. As a result, in the aspect of the invention, the first ideal central axis and the second ideal central axis are brought into coincidence with each other.

Therefore, in the spectroscopic camera according to the aspect of the invention, the ideal central axes of the incident angle limiter and the spectroscopic device coincide with each other, whereby measurement precision in the vicinity of the central coordinates in an acquired spectroscopic image can be improved and hence a high-precision spectroscopic image can be captured.

Another aspect of the invention is directed to a spectroscopic camera including a spectroscopic device that selects light of a predetermined wavelength from incident light and transmits the selected light, an incident angle limiter that limits the angle of incidence of the incident light incident on the spectroscopic device to a value smaller than or equal to a predetermined angle, and an imaging device that receives light having passed through the spectroscopic device. The incident angle limiter has a first alignment mark indicating a mechanical central axis of the incident angle limiter, the spectroscopic device has a second alignment mark indicating a mechanical central axis of the spectroscopic device, and the imaging device has a third alignment mark indicating a mechanical central axis of the imaging device. An axis shifted from the mechanical central axis of the incident angle limiter not only by the amount of deviation of the mechanical central axis of the incident angle limiter from a first ideal central axis passing through a position where the angle of incidence of the incident light is limited to a predetermined ideal angle in the incident angle limiter but also by the angle of rotation indicating the direction of the deviation coincides with an axis shifted from the mechanical central axis of the spectroscopic device not only by the amount of deviation of the mechanical central axis of the spectroscopic device from a second ideal central axis passing through a position where light of a wavelength at the center of a transmission wavelength region in the spectroscopic device is transmitted but also by the angle of rotation indicating the direction of the deviation, and an axis shifted from the mechanical central axis of the imaging device not only by the amount of deviation of the mechanical central axis of the imaging device from a predetermined third ideal central axis passing through a position where incident light is received by the imaging device at predetermined ideal sensitivity but also by the angle of rotation indicating the direction of the deviation coincides with the axis shifted from the mechanical central axis of the spectroscopic device not only by the amount of deviation of the mechanical central axis of the spectroscopic device from the second ideal central axis thereof but also by the angle of rotation indicating the direction of the deviation.

In the aspect of the invention, the mechanical central axis of the imaging device is an imaginary axis passing through a point corresponding to the central pixel of a captured image.

In the aspect of the invention, the amount of deviation of the mechanical central axis of the imaging device from the third ideal central axis and the angle of rotation indicating the direction of the deviation are measured as a third adjustment amount as well as the first and second adjustment amounts described above.

In the adjustment of the alignment between the spectroscopic device and the imaging device as well, adjusting the positions of the second alignment mark and the third alignment mark relative to each other by using the second adjustment amount and the third adjustment amount allows the second ideal central axis and the third ideal central axis to coincide with each other, as in the adjustment of the alignment between the incident angle limiter and the spectroscopic device described above.

Therefore, in the spectroscopic camera according to the aspect of the invention, the ideal central axes of the incident angle limiter, the spectroscopic device, and the imaging device coincide with each other, whereby measurement precision in the vicinity of the central coordinates in an acquired spectroscopic image can be further improved and hence a high-precision spectroscopic image can be captured.

In the spectroscopic camera according to the aspect of the invention, it is preferable that the spectroscopic device includes a first reflection film that reflects part of incident light and transmits at least part of the incident light, a second reflection film that faces the first reflection film, reflects part of incident light, and transmits at least part of the incident light, and a gap changer that changes the dimension of a gap between the first reflection film and the second reflection film.

With this configuration, a wavelength tunable Fabry-Perot etalon in which incident light is brought into a space between a pair of reflection films and light of a wavelength selected in a multiple beam interference process is transmitted is used as the spectroscopic device.

The thus configured Fabry-Perot etalon allows spectroscopic images corresponding to a plurality of wavelengths to be acquired by changing the dimension of the gap between the reflection films. Further, in the Fabry-Perot etalon, a point where light of the wavelength at the center of the transmission wavelength region is primarily transmitted is called a setting point and the setting point is used to set an ideal central axis. As a result, measurement precision in the vicinity of the central coordinates in an acquired spectroscopic image can be improved, whereby a high-precision spectroscopic image can be captured.

Further, using a Fabry-Perot etalon allows size reduction as compared with a case where an AOTF (acousto-optic tunable filter), an LCTF (liquid crystal tunable filter), or any other large spectroscopic device is used, whereby the size of the spectroscopic camera can be reduced.

In the spectroscopic camera according to the aspect of the invention, it is preferable that the spectroscopic camera further includes a first mount that holds the incident angle limiter and a second mount to which the first mount is fixed, the first mount is provided with a first engaging portion having a recessed spherical surface, the second mount is provided with a second engaging portion having a protruding spherical surface that comes into contact with the recessed spherical surface of the first engaging portion, and the centers of curvature of the protruding spherical surface and the recessed spherical surface coincide with an intersection point of the imaging device and the third ideal central axis.

With this configuration, the center of curvature of the recessed spherical surface of the first engaging portion and the center of curvature of the protruding spherical surface of the second engaging portion coincide with an ideal center point of the imaging device (point on third ideal central axis of imaging device). In this configuration, changing the position where the first engaging portion engages with the second engaging portion allows adjustment of the optical axis direction of the incident angle limiter held by the first mount, and adjusting the ideal center point of the imaging device to be located on the optical axis of the incident angle limiter allows light incident through the incident angle limiter to be focused on the imaging device with precision.

Still another aspect of the invention is directed to an alignment adjustment method for adjusting alignment of a spectroscopic device that selects light of a predetermined wavelength from incident light and transmits the selected light, an incident angle limiter that limits the angle of incidence of the incident light incident on the spectroscopic device to a value smaller than or equal to a predetermined angle, and an imaging device that receives light having passed through the spectroscopic device in a spectroscopic camera including the spectroscopic device, the incident angle limiter and the imaging device. The incident angle limiter has a first alignment mark indicating a mechanical central axis of the incident angle limiter. The spectroscopic device has a second alignment mark indicating a mechanical central axis of the spectroscopic device, and the imaging device has a third alignment mark indicating a mechanical central axis of the imaging device. The alignment adjustment method includes measuring a first adjustment amount that is a combination of the amount of deviation of the mechanical central axis of the incident angle limiter from a first ideal central axis indicating a position where the angle of incidence of the incident light is limited to an ideal angle in the incident angle limiter and the angle of rotation indicating the direction of the deviation, measuring a second adjustment amount that is a combination of the amount of deviation of the mechanical central axis of the spectroscopic device from a second ideal central axis indicating a position where light of a central wavelength out of light that the spectroscopic device transmits is transmitted and the angle of rotation indicating the direction of the deviation, measuring a third adjustment amount that is a combination of the amount of deviation of the mechanical central axis of the imaging device from a third ideal central axis indicating a position where incident light is received by the imaging device at predetermined set sensitivity and the angle of rotation indicating the direction of the deviation, adjusting the positions of the first alignment mark and the second alignment mark relative to each other in accordance with the first adjustment amount and the second adjustment amount in such a way that the first ideal central axis and the second ideal central axis coincide with each other, and adjusting the positions of the second alignment mark and the third alignment mark relative to each other in accordance with the second adjustment amount and the third adjustment amount in such a way that the second ideal central axis and the third ideal central axis coincide with each other.

In the aspect of the invention, the first adjustment amount, which is a combination of the amount of deviation of the mechanical central axis of the incident angle limiter from the ideal central axis thereof (first ideal central axis) and the angle of rotation indicating the direction of the deviation, the second adjustment amount, which is a combination of the amount of deviation of the mechanical central axis of the spectroscopic device from the ideal central axis thereof (second ideal central axis) and the angle of rotation indicating the direction of the deviation, and the third adjustment amount, which is a combination of the amount of deviation of the mechanical central axis of the imaging device from the ideal central axis thereof (third ideal central axis) and the angle of rotation indicating the direction of the deviation are measured. The first adjustment amount and the second adjustment amount are then used to adjust the position of the first alignment mark on the incident angle limiter and the position of the second alignment mark on the spectroscopic device in such a way that the first ideal central axis and the second ideal central axis coincide with each other. Further, the second adjustment amount and the third adjustment amount are used to adjust the position of the second alignment mark on the spectroscopic device and the position of the third alignment mark on the imaging device in such a way that the second ideal central axis and the third ideal central axis coincide with each other.

As a result, the ideal central axes of the incident angle limiter, the spectroscopic device, and the imaging device are brought into coincidence with one another, as in the aspect of the invention described above, whereby a spectroscopic camera capable of capturing a high-precision spectroscopic image can be assembled.

Yet another aspect of the invention is directed to an alignment adjustment method for adjusting alignment of a spectroscopic device that selects light of a predetermined wavelength from incident light and transmits the selected light, an incident angle limiter that limits the angle of incidence of the incident light incident on the spectroscopic device to a value smaller than or equal to a predetermined angle, and an imaging device that receives light having passed through the spectroscopic device in a spectroscopic camera including the spectroscopic device, the incident angle limiter and the imaging device. The incident angle limiter has a first alignment mark indicating a mechanical central axis of the incident angle limiter, the spectroscopic device has a second alignment mark indicating a mechanical central axis of the spectroscopic device, and the imaging device has a third alignment mark indicating a mechanical central axis of the imaging device. The alignment adjustment method includes measuring a first adjustment amount that is a combination of the amount of deviation of the mechanical central axis of the incident angle limiter from a first ideal central axis indicating a position where the angle of incidence of the incident light is limited to an ideal angle in the incident angle limiter and the angle of rotation indicating the direction of the deviation, measuring a second adjustment amount that is a combination of the amount of deviation of the mechanical central axis of the spectroscopic device from a second ideal central axis indicating a position where light of a central wavelength out of light that the spectroscopic device transmits is transmitted and the angle of rotation indicating the direction of the deviation, measuring a third adjustment amount that is a combination of the amount of deviation of the mechanical central axis of the imaging device from a third ideal central axis indicating a position where incident light is received by the imaging device at predetermined set sensitivity and the angle of rotation indicating the direction of the deviation, adjusting the positions of the first alignment mark and the second alignment mark relative to each other in accordance with the first adjustment amount and the second adjustment amount in such a way that the first ideal central axis and the second ideal central axis coincide with each other, and adjusting the positions of the first alignment mark and the third alignment mark relative to each other in accordance with the first adjustment amount and the third adjustment amount in such a way that the first ideal central axis and the third ideal central axis coincide with each other.

In the aspect of the invention, the first adjustment amount and the second adjustment amount are used to adjust the position of the first alignment mark on the incident angle limiter and the position of the second alignment mark on the spectroscopic device in such a way that the first ideal central axis and the second ideal central axis coincide with each other, as in the aspect of the invention described above. On the other hand, the first adjustment amount and the third adjustment amount are used to adjust the position of the first alignment mark on the incident angle limiter and the position of the third alignment mark on the imaging device in such a way that the first ideal central axis and the third ideal central axis coincide with each other. In this case, the ideal central axes of the incident angle limiter, the spectroscopic device, and the imaging device can be brought into coincidence with one another, as in the aspect of the invention described above, whereby a spectroscopic camera capable of capturing a high-precision spectroscopic image can be assembled.

Still yet another aspect of the invention is directed to an alignment adjustment method for adjusting alignment of a spectroscopic device that selects light of a predetermined wavelength from incident light and transmits the selected light, an incident angle limiter that limits the angle of incidence of the incident light incident on the spectroscopic device to a value smaller than or equal to a predetermined angle, and an imaging device that receives light having passed through the spectroscopic device in a spectroscopic camera including the spectroscopic device, the incident angle limiter and imaging device. The incident angle limiter has a first alignment mark indicating a mechanical central axis of the incident angle limiter, the spectroscopic device has a second alignment mark indicating a mechanical central axis of the spectroscopic device, and the imaging device has a third alignment mark indicating a mechanical central axis of the imaging device. The alignment adjustment method includes measuring a first adjustment amount that is a combination of the amount of deviation of the mechanical central axis of the incident angle limiter from a first ideal central axis indicating a position where the angle of incidence of the incident light is limited to an ideal angle in the incident angle limiter and the angle of rotation indicating the direction of the deviation, measuring a second adjustment amount that is a combination of the amount of deviation of the mechanical central axis of the spectroscopic device from a second ideal central axis indicating a position where light of a central wavelength out of light that the spectroscopic device transmits is transmitted and the angle of rotation indicating the direction of the deviation, measuring a third adjustment amount that is a combination of the amount of deviation of the mechanical central axis of the imaging device from a third ideal central axis indicating a position where incident light is received by the imaging device at predetermined set sensitivity and the angle of rotation indicating the direction of the deviation, adjusting the positions of the first alignment mark and the third alignment mark relative to each other in accordance with the first adjustment amount and the third adjustment amount in such a way that the first ideal central axis and the third ideal central axis coincide with each other, and adjusting the positions of the second alignment mark and the third alignment mark relative to each other in accordance with the second adjustment amount and the third adjustment amount in such a way that the second ideal central axis and the third ideal central axis coincide with each other.

In the aspect of the invention, the first adjustment amount and the third adjustment amount are used to adjust the position of the first alignment mark on the incident angle limiter and the position of the third alignment mark on the imaging device in such a way that the first ideal central axis and the third ideal central axis coincide with each other. Further, the second adjustment amount and the third adjustment amount are used to adjust the position of the second alignment mark on the spectroscopic device and the position of the third alignment mark on the imaging device in such a way that the second ideal central axis and the third ideal central axis coincide with each other. In this case, the ideal central axes of the incident angle limiter, the spectroscopic device, and the imaging device can be brought into coincidence with one another, as in the aspect of the invention described above, whereby a spectroscopic camera capable of capturing a high-precision spectroscopic image can be assembled.

Further another aspect of the invention is directed to a spectroscopic camera including a spectroscopic device that selects light of a predetermined wavelength from incident light and transmits the selected light, an incident angle limiter that limits the angle of incidence of the incident light incident on the spectroscopic device to a value smaller than or equal to a predetermined angle, and an imaging device that receives light having passed through the spectroscopic device. The incident angle limiter has a first alignment mark that defines the positional relationship between the incident angle limiter and a first ideal central axis passing through a position where the angle of incidence of the incident light is limited to a predetermined ideal angle in the incident angle limiter, and the positional relationship between the first ideal central axis and the incident angle limiter varies from one incident angle limiter to another. The spectroscopic device has a second alignment mark that defines the positional relationship between the spectroscopic device and a second ideal central axis passing through a position where light of a wavelength at the center of a transmission wavelength region in the spectroscopic device is transmitted, and the positional relationship between the second ideal central axis and the spectroscopic device varies from one spectroscopic device to another. The imaging device has a third alignment mark that defines the relative positional relationship between the imaging device and a third ideal central axis passing through a position where incident light is received by the imaging device at predetermined ideal sensitivity, and the positional relationship between the third ideal central axis and the imaging device varies from one imaging device to another. The first ideal central axis, the second ideal central axis, and the third ideal central axis coincide with each other.

In the aspect of the invention, the first ideal central axis of the incident angle limiter, the second ideal central axis of the spectroscopic device, and the third ideal central axis of the imaging device coincide with each other, as in the aspect of the invention described above. As a result, in the spectroscopic camera according to the aspect of the invention, the ideal central axes of the incident angle limiter, the spectroscopic device, and the imaging device coincide with one another, whereby measurement precision in the vicinity of the central coordinates in an acquired spectroscopic image can be improved and hence a high-precision spectroscopic image can be captured.

In the aspect of the invention, the first alignment mark only needs to define the positional relationship between the incident angle limiter and the first ideal central axis, the second alignment mark only needs to define the positional relationship between the spectroscopic device and the second ideal central axis, and the third alignment mark only needs to define the positional relationship between the imaging device and the third ideal central axis. That is, the first alignment mark is not necessarily a mark indicating the mechanical central axis of the incident angle limiter, the second alignment mark is not necessarily a mark indicating the mechanical central axis of the spectroscopic device, or the third alignment mark is not necessarily a mark indicating the mechanical central axis of the imaging device.

### BRIEF DESCRIPTION OF THE DRAWINGS

The invention will be described with reference to the accompanying drawings, wherein like numbers reference like elements.

FIG. 1 is a perspective view showing a front-side configuration of a spectroscopic camera according to a first embodiment.

FIG. 2 shows a schematic internal configuration of the spectroscopic camera according to the first embodiment.

FIG. 3 is a plan view schematically showing a wavelength tunable interference filter in the spectroscopic camera according to the first embodiment.

FIG. 4 is a cross-sectional view of the wavelength tunable interference filter taken along the line IV-IV in FIG. 3.

FIG. 5 is a flowchart showing an alignment adjustment method in the spectroscopic camera according to the first embodiment.

FIG. 6 describes the alignment adjustment method in the spectroscopic camera according to the first embodiment.

FIG. 7 describes a first alignment step in the first embodiment.

FIG. 8 describes a second alignment step in the first embodiment.

FIG. 9 is a flowchart showing an alignment adjustment method in a first variation of the first embodiment.

FIG. 10 describes an alignment adjustment method in a second variation of the first embodiment.

FIG. 11 is a flowchart of the alignment adjustment method in the second variation of the first embodiment.

FIG. 12 describes an alignment adjustment method in a third variation of the first embodiment.

FIG. 13 is a flowchart of the alignment adjustment method in the third variation of the first embodiment.

FIG. 14 is a plan view schematically showing a light incident section in a second embodiment.

FIG. 15 is a side view schematically showing a structure that attaches the light incident section in the second embodiment.

### DESCRIPTION OF EXEMPLARY EMBODIMENTS

### First Embodiment

A spectroscopic camera according to a first embodiment of the invention will be described below with reference to the drawings.

### Schematic Configuration of Spectroscopic Camera

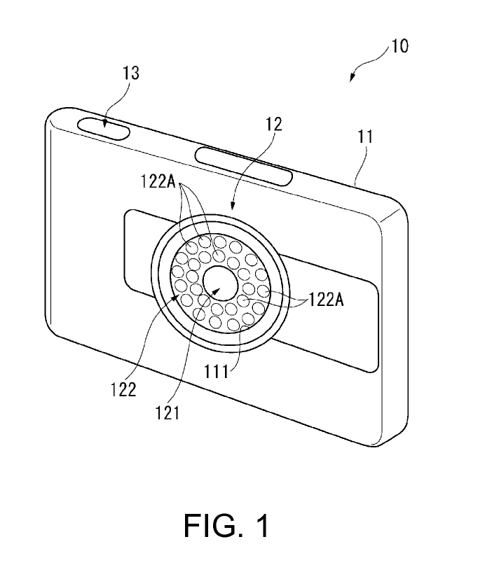

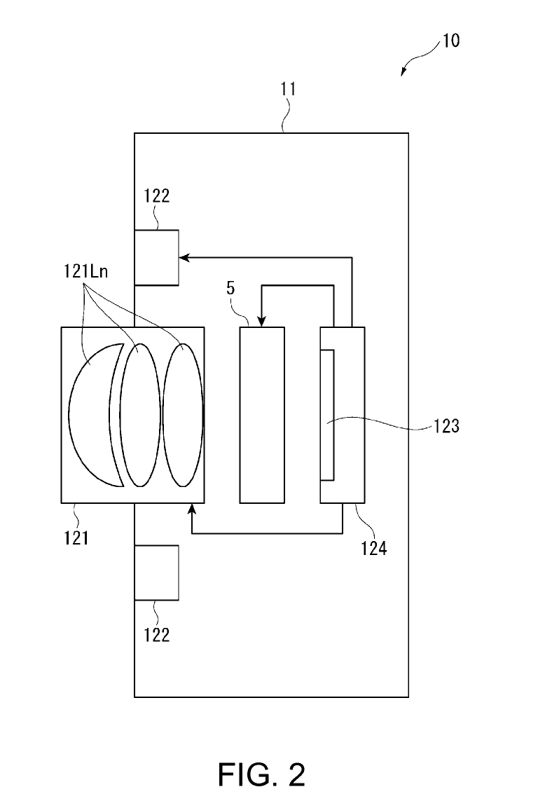

FIG. 1 is a perspective view showing a front-side configuration of the spectroscopic camera according to the first embodiment. FIG. 2 is a schematic view showing a schematic internal configuration of the spectroscopic camera.

A spectroscopic camera 10 is a spectroscopic camera according to an embodiment of the invention and an apparatus that captures spectroscopic images of an imaging target object at a plurality of wavelengths.

The spectroscopic camera 10 according to the present embodiment includes an enclosure 11, an imaging module 12, a display (not shown), and an operation section 13, as shown in FIGS. 1 and 2.

### Configuration of Enclosure

The enclosure 11 has a thin-box-like shape that has a thickness ranging, for example, from about 1 to 2 cm and can be readily put, for example, in a pocket of clothing. The enclosure 11 has an imaging window 111, in which the imaging module 12 is disposed. Part of the enclosure 11 forms the operation section 13 (shutter button, for example).

### Configuration of Operation Section

The operation section 13 is formed of the shutter button provided on the enclosure 11 as described above, a touch panel provided on the display, and other components. When a user performs input operation, the operation section 13 outputs an operation signal according to the input operation to a circuit substrate 124.

### Configuration of Imaging Module

The imaging module 12 includes a light incident section 121, which is so provided that it faces the imaging window 111, a light source section 122, which is so provided that it faces the imaging window 111, a wavelength tunable interference filter 5 (spectroscopic device), and the circuit substrate 124, on which an imaging device 123, which receives incident light, is provided.

### Configuration of Light Incident Section

The light incident section 121 is formed of a plurality of lenses, as shown in FIG. 2. The light incident section 121 has a telecentric optical system formed of a plurality of lenses 121Ln, limits the viewing angle to a predetermined angle or smaller, and forms an image of an object under inspection within the viewing angle on the imaging device 123. That is, the light incident section 121 forms a viewing angle limiter according to an embodiment of the invention. The thus configured telecentric optical system can align the principal ray of incident light with a direction parallel to the optical axis, whereby the aligned light can be incident on a fixed reflection film 54 and a movable reflection film 55 of the wavelength tunable interference filter 5, which will be described later, at right angles. Further, an aperture is provided in the focal position of the lenses 121Ln, which form the telecentric optical system. The aperture has an aperture diameter controlled in accordance, for example, with user's operation and can therefore control the viewing angle. The angle of incidence of the incident light, which is limited by the lenses 121Ln, the aperture, and other components of the telecentric optical system, is preferably limited, although it varies depending on lens design and other factors, to 20 degrees or smaller with respect to the optical axis.

The light incident section 121 is preferably provided with an enlargement/reduction optical system as well as the components described above. Provision of the enlargement/reduction optical system allows an acquired image to be enlarged or reduced through adjustment of an inter-lens gap, for example, accordance to user's operation.

The positions where the light incident section 121, the wavelength tunable interference filter 5, and the circuit substrate 124, on which the imaging device 123 is provided, are fixed will be described later in detail.

### Configuration of Light Source Section

The light source section 122 includes a plurality of light sources 122A (LEDs), which are arranged in an annular shape along the outer circumference of the imaging window 111, as shown in FIGS. 1 and 2. The LEDs presented as the light sources 122A in the present embodiment by way of example may be replaced, for example, with laser light sources. Using LEDs or laser light sources as the light sources 122A allows reduction both in size of the light source section 122 and in power consumption.

### Configuration of Wavelength Tunable Interference Filter

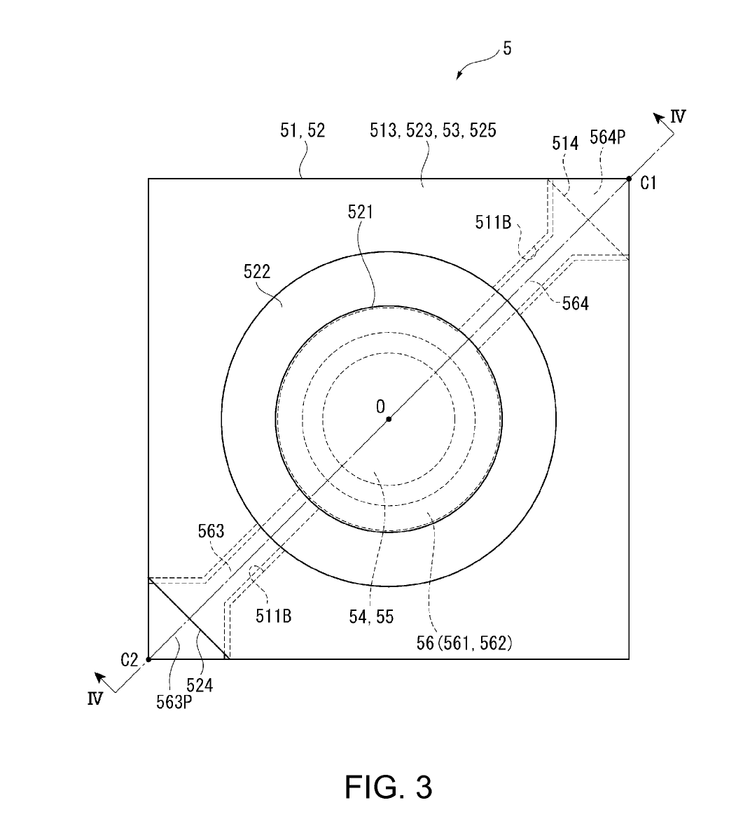

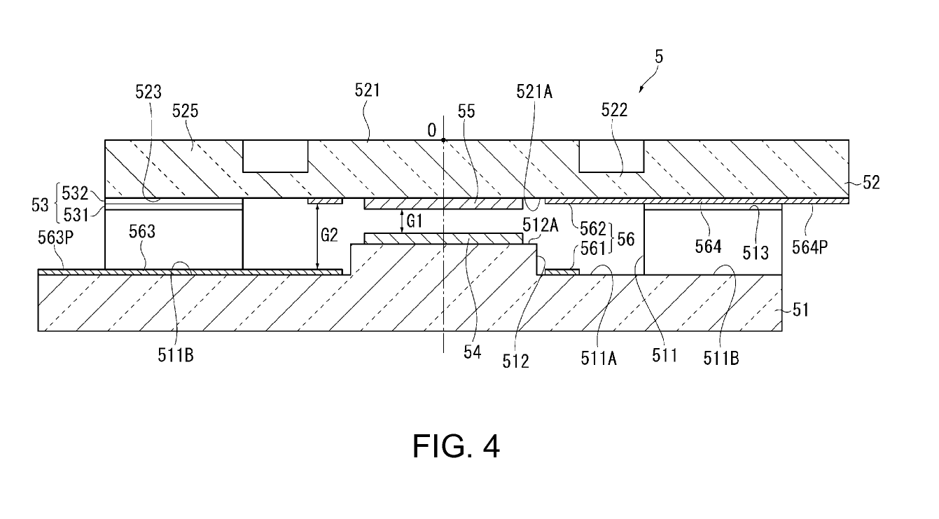

FIG. 3 is a plan view showing a schematic configuration of the wavelength tunable interference filter. FIG. 4 is a cross-sectional view of the wavelength tunable interference filter taken along the line IV-IV in FIG. 3.

The wavelength tunable interference filter 5 is a Fabry-Perot etalon. The wavelength tunable interference filter 5 is, for example, a rectangular-plate-shaped optical member and includes a fixed substrate 51, which is formed to a thickness of, for example, about 500 μm, and a movable substrate 52, which is formed to a thickness of, for example, about 200 μm. Each of the fixed substrate 51 and the movable substrate 52 is made, for example, of soda glass, crystalline glass, quartz glass, lead glass, potassium glass, borosilicate glass, no-alkali glass, or any of a variety of other glass materials, or quartz. A first bonding portion 513 of the fixed substrate 51 and a second bonding portion 523 of the movable substrate are bonded to each other via a bonding film 53 (first bonding film 531 and second bonding film 532) formed, for example, of a plasma polymerization film primarily made, for example, of siloxane so that the fixed substrate 51 and the movable substrate 52 are integrated with each other.

A fixed reflection film 54 is provided on the fixed substrate 51, and a movable reflection film 55 is provided on the movable substrate 52. The fixed reflection film 54 and the movable reflection film 55 are so disposed that they face each other via an inter-reflection-film gap G1. The wavelength tunable interference filter 5 is provided with an electrostatic actuator 56, which is used to adjust (change) the size of the inter-reflection-film gap G1. The electrostatic actuator 56 is formed of a fixed electrode 561 provided on the fixed substrate 51 and a movable electrode 562 provided on the movable substrate 52. The fixed electrode 561 and the movable electrode 562 face each other via an inter-electrode gap G2. The fixed electrode 561 and the movable electrode 562 may be directly provided on substrate surfaces of the fixed substrate 51 and the movable substrate 52, respectively, or may be provided thereon via other film members. The size of the inter-electrode gap G2 is greater than the size of the inter-reflection-film gap G1.

In a filter plan view or FIG. 3 in which the wavelength tunable interference filter 5 is viewed in the substrate thickness direction of the fixed substrate 51 (movable substrate 52), a plan-view center point O of the fixed substrate 51 and the movable substrate 52 coincides with not only the center point of the fixed reflection film 54 and the center point of the movable reflection film 55 but also the center point of a movable portion 521, which will be described later.

In the following description, a plan view viewed in the substrate thickness direction of the fixed substrate 51 or the movable substrate 52, that is, a plan view in which the wavelength tunable interference filter 5 is viewed in the direction in which the fixed substrate 51, the bonding film 53, and the movable substrate 52 are layered on each other is referred to as the filter plan view.

### Configuration of Fixed Substrate

The fixed substrate 51 has an electrode placement groove 511 and a reflection film attachment portion 512 formed therein in an etching process. The fixed substrate 51 is formed to be thicker than the movable substrate 52 and is not therefore bent by an electrostatic attractive force produced when a voltage is applied between the fixed electrode 561 and the movable electrode 562 or internal stress induced in the fixed electrode 561.

Further, a cutout 514 is formed at a vertex C1 of the fixed substrate 51 and exposes a movable electrode pad 564P, which will be described later and faces the fixed substrate 51 of the wavelength tunable interference filter 5.

The electrode placement groove 511 is so formed that it has an annular shape around the plan-view center point O of the fixed substrate 51 in the filter plan view. The reflection film attachment portion 512 is so formed that it protrudes from a central portion of the electrode placement groove 511 in the plan view described above toward the movable substrate 52. A groove bottom surface of the electrode placement groove 511 forms an electrode attachment surface 511A, on which the fixed electrode 561 is disposed. Further, the front end surface of the thus protruding reflection film attachment portion 512 forms a reflection film attachment surface 512A.

Further, electrode drawing grooves 511B, which extend from the electrode placement groove 511 toward the vertices C1 and C2 at the outer circumferential edge of the fixed substrate 51, are provided in the fixed substrate 51.

The fixed electrode 561 is disposed on the electrode attachment surface 511A of the electrode placement groove 511. More specifically, the fixed electrode 561 is disposed on the electrode attachment surface 511A in an area facing the movable electrode 562 on the movable portion 521, which will be described later. An insulating film for ensuring insulation between the fixed electrode 561 and the movable electrode 562 may be layered on the fixed electrode 561.

A fixed drawn electrode 563 is provided on the fixed substrate 51 and extends from the outer circumferential edge of the fixed electrode 561 toward the vertex C2. A front end portion of the thus extending fixed drawn electrode 563 (portion located at vertex C2 of fixed substrate 51) forms a fixed electrode pad 563P, which is connected to the circuit substrate 124.

The present embodiment has a configuration in which the single fixed electrode 561 is provided on the electrode attachment surface 511A but may instead have, for example, a configuration in which two concentric electrodes formed around the plan-view center point O are provided on the electrode attachment surface 511A (dual electrode configuration).

The reflection film attachment portion 512 is coaxial with the electrode placement groove 511, has a substantially cylindrical shape having a diameter smaller than that of the electrode placement groove 511, and has the reflection film attachment surface 512A facing the movable substrate 52, as described above.

The fixed reflection film 54 is disposed on the reflection film attachment portion 512, as shown in FIG. 4. The fixed reflection film 54 can be formed, for example, of a metal film made, for example, of Ag or an alloy film made, for example, of an Ag alloy. The fixed reflection film 54 may instead be formed of a dielectric multilayer film, for example, having a high refractive layer made of TiO₂ and a low refractive layer made of SiO₂. The fixed reflection film 54 may still instead be a reflection film formed of a metal film (or alloy film) layered on a dielectric multilayer film, a reflection film formed of a dielectric multilayer film layered on a metal film (or alloy film), or a reflection film that is a laminate of a single-layer refractive layer (made, for example, of TiO₂ or SiO₂) and a metal film (or alloy film).

An antireflection film may be formed on a light incident surface of the fixed substrate 51 (surface on which fixed reflection film 54 is not provided) in a position corresponding to the fixed reflection film 54. The antireflection film can be formed by alternately layering a low refractive index film and a high refractive index film on each other, and the thus formed antireflection film decreases light reflectance of the surface of the fixed substrate 51 whereas increasing light transmittance thereof.

Part of the surface of the fixed substrate 51 that faces the movable substrate 52, specifically, the surface where the electrode placement groove 511, the reflection film attachment portion 512, or the electrode drawing grooves 511B are not formed in the etching process forms the first bonding portion 513. A first bonding film 531 is provided on the first bonding portion 513 and bonded to a second bonding film 532 provided on the movable substrate 52, whereby the fixed substrate 51 and the movable substrate 52 are bonded to each other as described above.

### Configuration of Movable Substrate

The movable substrate 52 has the movable portion 521, which is circular and formed around the plan-view center point O, a holding portion 522, which is coaxial with the movable portion 521 and holds the movable portion 521, and a substrate outer circumferential portion 525, which is provided in an area outside the holding portion 522, in the filter plan view or FIG. 3.

Further, the movable substrate 52 has a cutout 524 formed in correspondence with the vertex C2, and the cutout 524 exposes the fixed electrode pad 563P when the wavelength tunable interference filter 5 is viewed from the side where the movable substrate 52 is present, as shown in FIG. 3.

The movable portion 521 is formed to be thicker than the holding portion 522. In the present embodiment, for example, the movable portion 521 is formed to be as thick as the movable substrate 52. The movable portion 521 is so formed that it has a diameter greater than at least the diameter of the outer circumferential edge of the reflection film attachment surface 512A in the filter plan view. The movable electrode 562 and the movable reflection film 55 are disposed on the movable portion 521.

An antireflection film may be formed on the surface of the movable portion 521 that faces away from the fixed substrate 51, as in the case of the fixed substrate 51. The antireflection film can be formed by alternately layering a low refractive index film and a high refractive index film on each other, and the thus formed antireflection film decreases light reflectance of the surface of the movable substrate 52 whereas increasing light transmittance thereof.

The movable electrode 562 faces the fixed electrode 561 via the inter-electrode gap G2 and is so formed that it has an annular shape that conforms to the shape of the fixed electrode 561. A movable drawn electrode 564 is provided on the movable substrate 52 and extends from the outer circumferential edge of the movable electrode 562 toward a vertex C1 of the movable substrate 52. A front end portion of the thus extending movable drawn electrode 564P (portion located at vertex C1 of movable substrate 52) forms the movable electrode pad 564P, which is connected to the circuit substrate 124.

The movable reflection film 55 is so disposed on a central portion of a movable surface 521A of the movable portion 521 that the movable reflection film 55 faces the fixed reflection film 54 via the inter-reflection-film gap G1. The movable reflection film 55 has the same configuration as that of the fixed reflection film 54 described above.

In the present embodiment, the size of the inter-electrode gap G2 is greater than the size of the inter-reflection-film gap G1 as described above by way of example, but the sizes of the gaps are not necessarily set this way. For example, when light under measurement is infrared light or far infrared light, the size of the inter-reflection-film gap G1 may be greater than the size of the inter-electrode gap G2 depending on the wavelength region of the light under measurement.

The holding portion 522 is a diaphragm that surrounds the movable portion 521 and is formed to be thinner than the movable portion 521. The thus configured holding portion 522 is more readily bent than the movable portion 521 and can therefore displace the movable portion 521 toward the fixed substrate 51 under a small amount of electrostatic attractive force. Since the movable portion 521 is thicker and therefore more rigid than the holding portion 522, the movable portion 521 is not deformed when the holding portion 522 is attracted toward the fixed substrate 51 under an electrostatic attractive force. The movable reflection film 55 disposed on the movable portion 521 will therefore not be bent, whereby the fixed reflection film 54 and the movable reflection film 55 can be consistently maintained parallel to each other.

In the present embodiment, the diaphragm-shaped holding portion 522 is presented by way of example, but the holding portion 522 is not necessarily formed of a diaphragm. For example, beam-shaped holding portions disposed at equal angular intervals may be provided around the plan-view center point O.

The substrate outer circumferential portion 525 is disposed in an area outside the holding portion 522 in the filter plan view, as described above. The second bonding portion 523, which faces the first bonding portion 513, is provided on the surface of the substrate outer circumferential portion 525 that faces the fixed substrate 51. The second bonding film 532 is provided on the second bonding portion 523 and bonded to the first bonding film 513, whereby the fixed substrate 51 and the movable substrate 52 are bonded to each other as described above.

### Configuration of Circuit Substrate

The circuit substrate 124 includes the imaging device 123. The circuit substrate 124 further includes a voltage control circuit connected to the electrode pads 563P and 564P of the wavelength tunable interference filter 5, a light source control circuit that controls the light source section 122, an input circuit that receives an input signal from the operation section 13, a display control circuit that controls the display, and a variety of other circuits. The circuit substrate 124 still further includes a computation circuit formed, for example, of a CPU and a storage circuit formed, for example, of a memory.

The storage circuit stores, for example, V−λ data representing a drive voltage applied to the electrostatic actuator 56 in the wavelength tunable interference filter 5 versus the wavelength of light allowed to pass through the wavelength tunable interference filter 5 when the drive voltage is applied. The storage circuit further stores a variety of programs for controlling the spectroscopic camera. The computation circuit reads the variety of programs and executes them to acquire a spectroscopic image.

The imaging device 123 is integrated with the circuit substrate 124, and the alignment among the circuit substrate 124, the wavelength tunable interference filter 5, and the light incident section 121 is adjusted so that the alignment among the imaging device 123, the wavelength tunable interference filter 5, and the telecentric optical system, which is the incident angle limiter provided in the light incident section 121, is adjusted.

### Adjustment of Alignment Among Light Incident Section, Wavelength Tunable Interference Filter, and Imaging Device

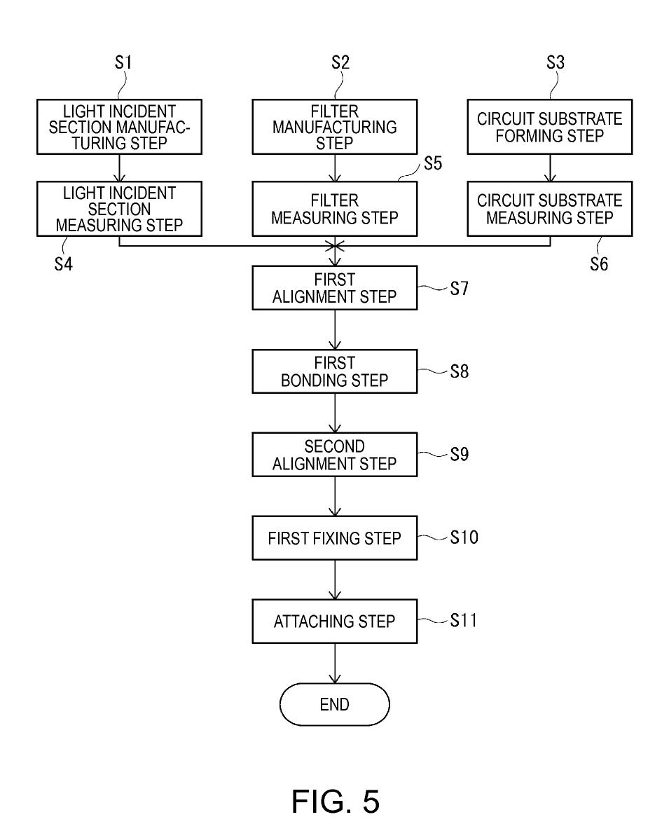

FIG. 5 is a flowchart showing an alignment adjustment method in the present embodiment.

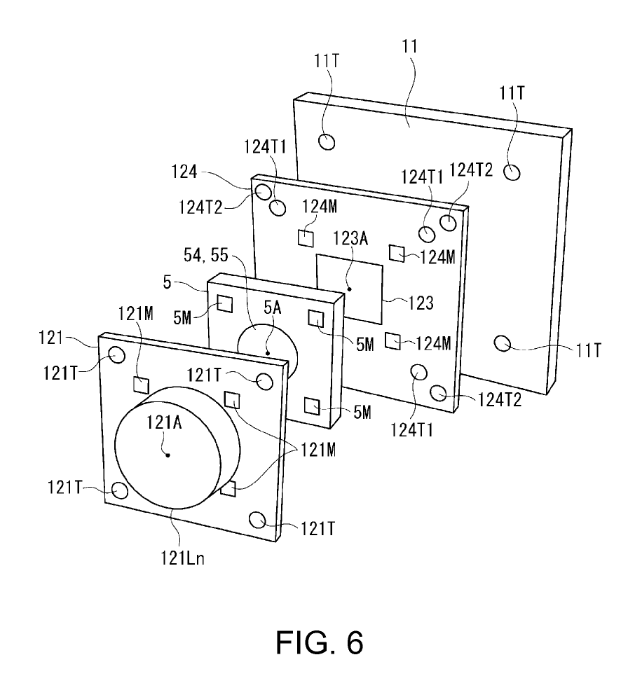

FIG. 6 describes the alignment adjustment method in the present embodiment.

In the spectroscopic camera 10 according to the present embodiment, adjusting the alignment among the circuit substrate 124, the wavelength tunable interference filter 5, and the light incident section 121 as described above allows ideal central axes thereof to coincide with one another.

Specifically, a light incident section manufacturing step S1 of manufacturing the light incident section 121, a filter manufacturing step S2 of manufacturing the wavelength tunable interference filter 5, and a circuit substrate forming step S3 of manufacturing the circuit substrate 124 are first carried out, as shown in FIG. 5.

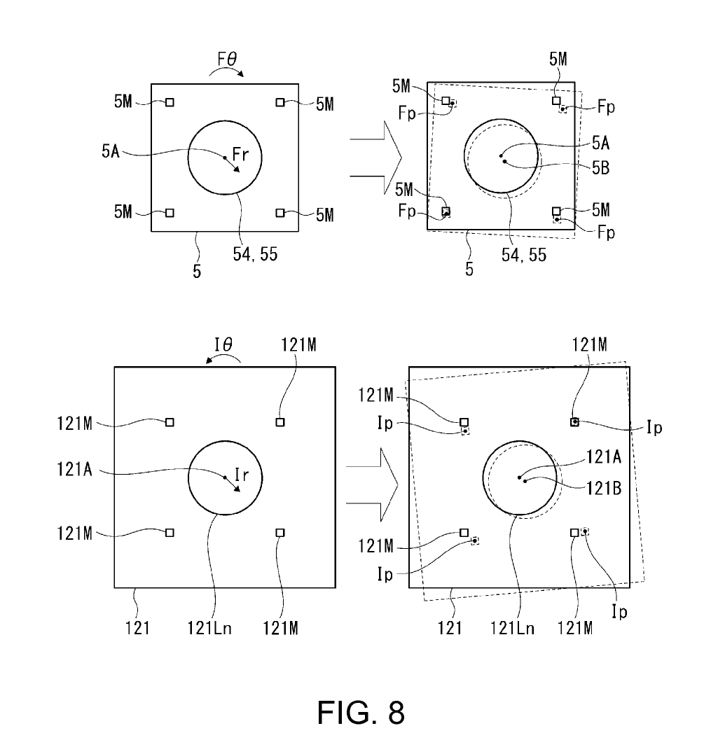

In the light incident section manufacturing step S1, the light incident section 121 described above is manufactured, and four or any other number of first alignment marks 121M are formed on the manufactured light incident section 121, as shown in FIG. 6. The first alignment marks 121M are, for example, marks for indicating the optical axis of the telecentric optical system (mechanical central axis of lenses 121Ln). In a plane in which the first alignment marks 121M are provided, a point equidistant from the first alignment marks 121M is a mechanical center point 121A (see FIG. 8) present on the mechanical central axis. The first alignment marks 121M may be painted or otherwise provided when the light incident section 121 is manufactured, or part of the configuration of the light incident section 121 (fixed threaded holes, for example) may serve as the first alignment marks 121M. The four first alignment marks 121M are provided by way of example, but the number of first alignment marks 121M is not limited to four. For example, three or more first alignment marks 121M may indicate the mechanical central axis, or five or more first alignment marks 121M may be provided.

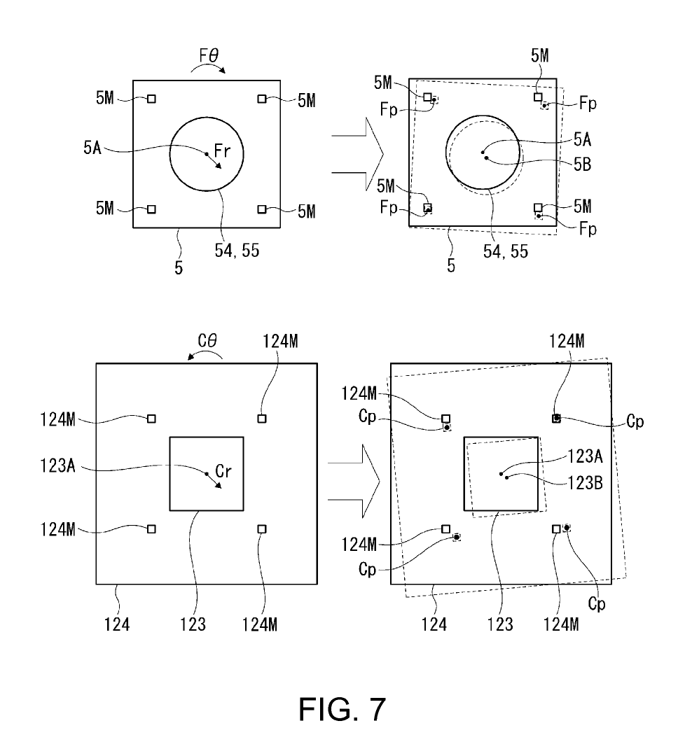

In the filter manufacturing step S2, the wavelength tunable interference filter 5 described above is manufactured, and four second alignment marks 5M, such as those shown in FIG. 6, are formed. The second alignment marks 5M are marks indicating a mechanical central axis passing the center points of the reflection films 54 and 55 of the wavelength tunable interference filter 5 (filter center point O). In a plane where the second alignment marks 5M are disposed, a point equidistant from the second alignment marks 5M is a mechanical center point 5A (see FIGS. 7 and 8).

The second alignment marks 5M may instead be the four corners of the fixed substrate 51 or the movable substrate 52 of the wavelength tunable interference filter 5, part of the electrode pads 563P and 564P of the wavelength tunable interference filter 5, or other constituent members of the wavelength tunable interference filter 5. The second alignment marks 5M may be painted or otherwise provided on the wavelength tunable interference filter 5.

In the present embodiment, the wavelength tunable interference filter 5 is directly bonded to the circuit substrate 124 by way of example, but the wavelength tunable interference filter 5 may, for example, be accommodated in an enclosure maintained under vacuum. In this case, the second alignment marks 5M may be provided on the enclosure that accommodates the wavelength tunable interference filter 5.

Instead of the four second alignment marks 5M, three second alignment marks 5M may be provided, or five or more second alignment marks 5M may be provided, as in the case of the first alignment marks 121M on the light incident section 121 described above.

In the circuit substrate forming step S3, the circuit substrate 124 described above on which the imaging device 123 is provided is formed, and third alignment marks 124M, such as those shown in FIG. 6, are formed. The third alignment marks 124M are marks indicating a mechanical central axis of the imaging device 123, and in a plane where the third alignment marks 124M are disposed, a point equidistant from the third alignment marks 124M is a mechanical center point 123A (see FIG. 7) of the imaging device 123. The third alignment marks 124M may be painted or otherwise provided when the circuit substrate 124 is manufactured, or part of the configuration of the circuit substrate 124 (fixed threaded holes or predetermined circuit chips on circuit substrate 124, for example) may serve as the third alignment marks 124M.

Instead of the four third alignment marks 124M, three third alignment marks 124M may be provided, or five or more third alignment marks 124M may be provided, as in the cases of the first alignment marks 121M and the second alignment marks 5M.

After the steps S1 to S3 described above, steps of measuring ideal central axes of the light incident section 121, the wavelength tunable interference filter 5, and the imaging device 123 and calculating the amount of deviation from each of the mechanical central axes described above and the angle of rotation indicating the direction of the deviation (light incident section measuring step S4, filter measuring step S5, and circuit substrate measuring step S6) are carried out.

The light incident section 121 has an ideal center point 121B (see FIG. 8), where the angle of incidence of light guided through the telecentric optical system is limited to a predetermined set angle (ideal angle) or smaller and an ideal central axis passing through the ideal center point 121B (first ideal central axis). The ideal center point 121B is assumed to be an intersection point of the plane where the first alignment marks 121M are disposed and the first ideal central axis.

In the light incident section measuring step S4, the ideal center point 121B and the ideal central axis of each light incident section 121 manufactured in the light incident section manufacturing step S1 are measured. The amount of deviation of the mechanical center point 121A of the light incident section 121 from the ideal center point 121B thereof and the angle of rotation indicating the deviation direction are measured as a first adjustment amount.

The wavelength tunable interference filter 5 has an ideal center point 5B (see FIGS. 7 and 8), through which light of the wavelength at the center of the transmission wavelength region passes when the movable portion 521 is displaced toward the fixed substrate 51, and an ideal central axis passing through the ideal center point 5B (second ideal central axis). The ideal center point 5B is assumed to be an intersection point of the plane where the second alignment marks 5M are disposed and the second ideal central axis.

The ideal center point 5B is a point where the V−λ data for controlling the wavelength tunable interference filter 5 are measured and set, and the relationship between a voltage V applied to the electrostatic actuator 56 and the wavelength of light allowed to pass through the ideal center point 5B is stored in the V−λ data described above.

In the filter measuring step S5, the ideal center point 5B and the ideal central axis of each wavelength tunable interference filter 5 manufactured in the filter manufacturing step S2 are measured. The amount of deviation of the mechanical center point 5A of the wavelength tunable interference filter 5 from the ideal center point 5B thereof and the angle of rotation indicating the deviation direction are measured as a second adjustment amount.

The imaging device 123 similarly has an ideal center point 123B (see FIG. 7), where the amount of received light is maximized, and an ideal central axis passing through the ideal center point 123B (third ideal central axis).

In the circuit substrate measuring step S6, the ideal center point 123B and the ideal central axis of each circuit substrate 124 formed in the circuit substrate forming step S3 are measured. The amount of deviation of the mechanical center point 121A of the light incident section 121 from the ideal center point 121B thereof and the angle of rotation indicating the deviation direction are measured as a third adjustment amount.

It is noted that the circuit substrate measuring step S6 may be omitted because the imaging device 123 can be so manufactured that the mechanical center point 123A and the ideal center point 123B coincide with each other with precision. In this case, the amount of deviation and the angle of rotation indicating the deviation direction that form a third adjustment amount are both “0”.

Alignment adjustment and fixation steps are then carried out.

In the steps, the second alignment marks 5M and the third alignment marks 124M are used to adjust the alignment between the wavelength tunable interference filter 5 and the circuit substrate 124 (first alignment step S7).

FIG. 7 is a schematic view showing the adjustment of the alignment between the wavelength tunable interference filter 5 and the circuit substrate 124. In FIG. 7, let Fr be the amount of deviation and Fθ be the angle of rotation indicating the deviation direction in the second adjustment amount measured for the wavelength tunable interference filter 5, and Cr be the amount of deviation and Cθ be the angle of rotation indicating the deviation direction in the third adjustment amount measured for the circuit substrate 124.

In the first alignment step S7, the alignment adjustment is made as follows: Registration points Fp are created by rotating the second alignment marks 5M on the wavelength tunable interference filter 5 by the angle of rotation Fθ and moving the rotated second alignment marks 5M by the amount of deviation Fr; registration points Cp are created by rotating the third alignment marks 124M on the circuit substrate 124 by the angle of rotation Cθ and moving the rotated third alignment marks 124M by the amount of deviation Cr; and the registration points Fp and Cp are brought into coincidence with each other.

When it is assumed that the mechanical central axis is not deviated from the ideal central axis (when third adjustment amount is “0”) in the circuit substrate measuring step S6, the positions Fp created by moving the second alignment marks 5M on the wavelength tunable interference filter 5 by the second adjustment amount are brought into coincidence with the third alignment marks 124M on the circuit substrate 124.

The circuit substrate 124 and the wavelength tunable interference filter 5 are then bonded to each other (first bonding step S8).

A method for bonding them may be bonding using Ag paste or any other material, adhesion using an adhesive, or any other method.

The second alignment marks 5M and the first alignment marks 121M are then used to adjust the alignment between the wavelength tunable interference filter 5 and the light incident section 121 (telecentric optical system) (second alignment step S9).

FIG. 8 is a schematic view showing the adjustment of the alignment between the wavelength tunable interference filter 5 and the light incident section 121. In FIG. 8, let Ir be the amount of deviation and Iθ be the angle of rotation indicating the deviation direction in the first adjustment amount measured for the light incident section 121.

The second alignment step S9 is carried out as follows: Registration points Fp are created by moving the second alignment marks 5M on the wavelength tunable interference filter 5 by the second adjustment amount; registration points Ip are created by rotating the first alignment marks 121M on the light incident section 121 by the angle of rotation Iθ and moving the rotated first alignment marks 121M by the amount of deviation Ir; and the registration points Fp and Ip are brought into coincidence with each other, as shown in FIG. 8.

The light incident section 121 is then fixed to the circuit substrate 124 by using fixing holes 121T provided in the light incident section 121 and fixing holes 124T1 provided in the circuit substrate 124 with the aid of screws or any other fasteners (first fixing step S10).

The circuit substrate 124 is then fixed to the enclosure 11 by using fixing holes 124T2 provided in the circuit substrate 124 and fixing holes 11T provided in the enclosure 11 with the aid of screws or any other fasteners (attaching step S11).

The light incident section 121, the wavelength tunable interference filter 5, and the imaging device 123 (circuit substrate 124) are thus fixed to the enclosure 11 with the alignment among the constituent members described above adjusted.

### Advantageous Effects of First Embodiment

In the spectroscopic camera 10 according to the present embodiment, the first adjustment amount, which is a combination of the following two values, is measured in advance: the amount of deviation Ir of the mechanical center points 121A of the plurality of lenses 121Ln, which form the telecentric optical system or the incident angle limiter, from the ideal center points 121B of the telecentric optical system; and the angle of rotation Iθ indicating the deviation direction. Similarly, the second adjustment amount, which is a combination of the following two values, is measured in advance: the amount deviation Fr of the mechanical center point 5A of the wavelength tunable interference filter 5 from the ideal center point 5B thereof; and the angle of rotation Fθ indicating the deviation direction. Similarly, the third adjustment amount, which is a combination of the following two values, is measured in advance: the amount deviation Cr of the mechanical center point 123A of the imaging device 123 from the ideal center point 123B thereof; and the angle of rotation Cθ indicating the deviation direction.

Further, the light incident section 121 has the first alignment marks 121M indicating the mechanical center point 121A. The wavelength tunable interference filter 5 has the second alignment marks 5M indicating the mechanical center point 5A. The circuit substrate 124 has the third alignment marks 124M indicating the mechanical center point 123A.

In the first alignment step S7, the alignment adjustment is so performed that the registration points Fp, which are created by moving the second alignment marks 5M on the wavelength tunable interference filter 5 by the second adjustment amount, are brought into coincidence with the registration points Cp, which are created by moving the third alignment marks 124M on the circuit substrate 124 by the third adjustment amount. In the second alignment step S9, the alignment adjustment is so performed that the registration points Fp on the wavelength tunable interference filter 5 are brought into coincidence with the registration points Ip, which are created by moving the first alignment marks 121M on the light incident section 121 by the first adjustment amount.

In the thus configured spectroscopic camera, the first ideal central axis passing through the ideal center point 121B of the telecentric optical system that forms the incident angle limiter in the light incident section 121, the second ideal central axis passing through the ideal center point 5B of the wavelength tunable interference filter 5, and the third ideal central axis passing through the ideal center point 123B of the imaging device 123 can be brought into coincidence with one another. Measurement precision can therefore be improved in the vicinity of the central pixel of an acquired spectroscopic image as compared with a case where the alignment among the light incident section 121, the wavelength tunable interference filter 5, and the imaging device 123 is adjusted based only on the mechanical center points, whereby a high-precision spectroscopic image can be acquired.

In the present embodiment, the wavelength tunable interference filter 5, which is a Fabry-Perot etalon of wavelength tunable type, is used as the spectroscopic device. The wavelength tunable interference filter 5 allows spectroscopic images corresponding to a plurality of wavelengths to be readily acquired by using the electrostatic actuator 56 to change the dimension of the gap G1 between the reflection films 54 and 55.

Further, using the thus configured wavelength tunable interference filter 5 allows size reduction as compared with a case where an AOTF, an LCTF, or any other large spectroscopic device is used, whereby the size of the spectroscopic camera 10 can be reduced.

### First Variation of First Embodiment

In the first embodiment described above, after the first alignment step S7, in which the wavelength tunable interference filter 5 and the circuit substrate 124 undergo the alignment adjustment and are then bonded to each other, in the second alignment step S9, the alignment between the wavelength tunable interference filter 5 and the light incident section 121 is adjusted and the light incident section 121 is fixed to the circuit substrate 124, but the above procedure is not necessarily employed.

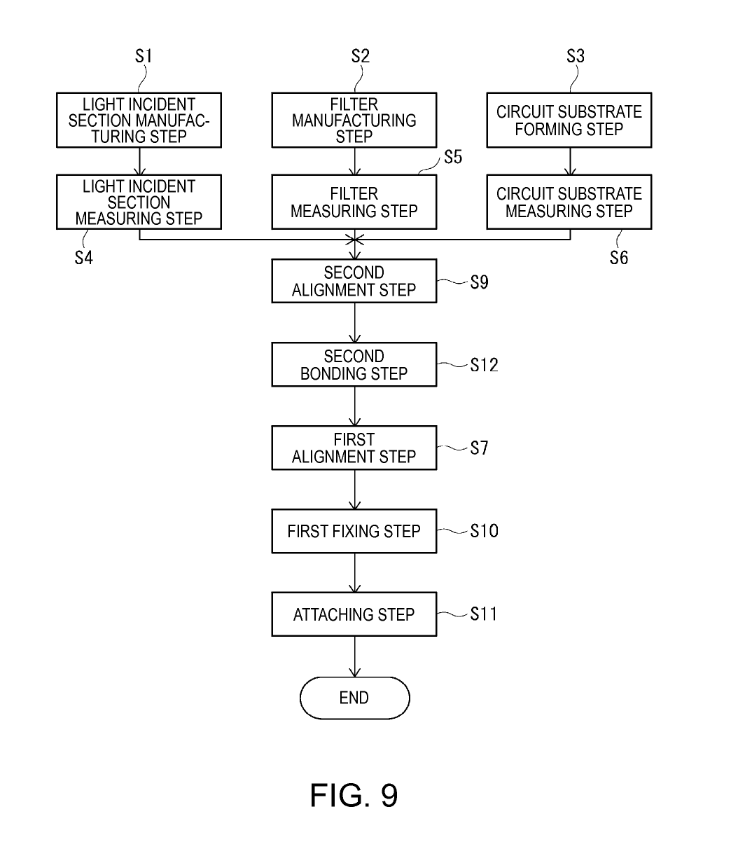

FIG. 9 is a flowchart showing an alignment adjustment method in the present variation. In the following description, the configurations and steps having already been described have the same reference characters and will not be described or described in a simplified manner.

In the present variation, after steps S1 to S6 are carried out, the second alignment step S9 in the first embodiment is carried out, in which the alignment between the wavelength tunable interference filter 5 and the light incident section 121 is adjusted.

The wavelength tunable interference filter 5 and the light incident section 121 are then bonded to each other (second bonding step S12). A method for bonding them can, for example, be a bonding method using an adhesive or any other material, as in the first bonding step S8.

The first alignment step S7 in the first embodiment described above is then carried out, in which the alignment between the wavelength tunable interference filter 5 and the circuit substrate 124 (imaging device 123) is adjusted.

The first fixing step S10 is then carried out, in which the light incident section 121 is fixed to the circuit substrate 124 by using the fixing holes 121T provided in the light incident section 121 and the fixing holes 124T1 provided in the circuit substrate 124 with the aid of screws or any other fasteners.

The attaching step S11 is then carried out.

Using the method described above also allows the ideal center points of the telecentric optical system that forms the incident angle limiter in the light incident section 121, the wavelength tunable interference filter 5, and the imaging device 123 to be aligned with one another along a single axis after the first alignment step S7 and the second alignment step S9 are carried out, whereby a high-precision spectroscopic image can be acquired.

### Second Variation of First Embodiment

In the first embodiment and the first variation described above, the light incident section 121 and the circuit substrate 124 are fixed to each other by using the fixing holes 121T in the light incident section 121 and the fixing holes 124T1 in the circuit substrate 124 with the aid of screws or any other fasteners by way of example.

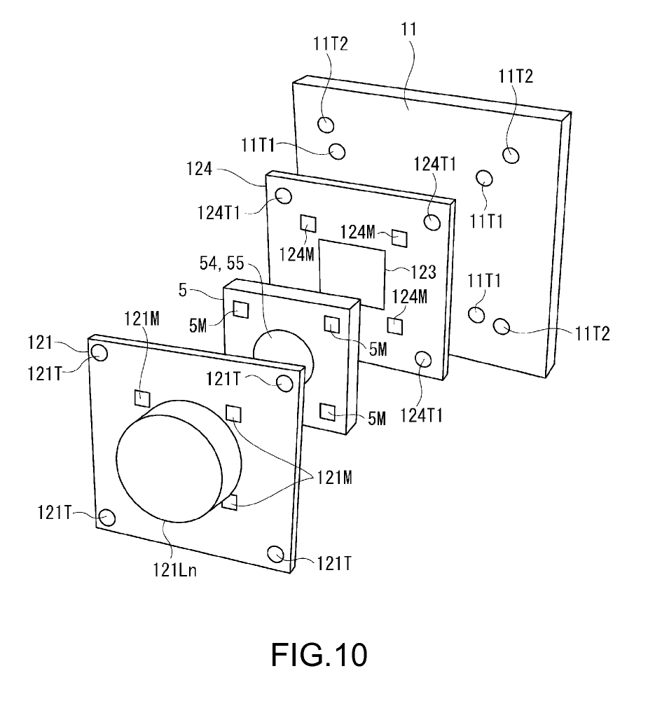

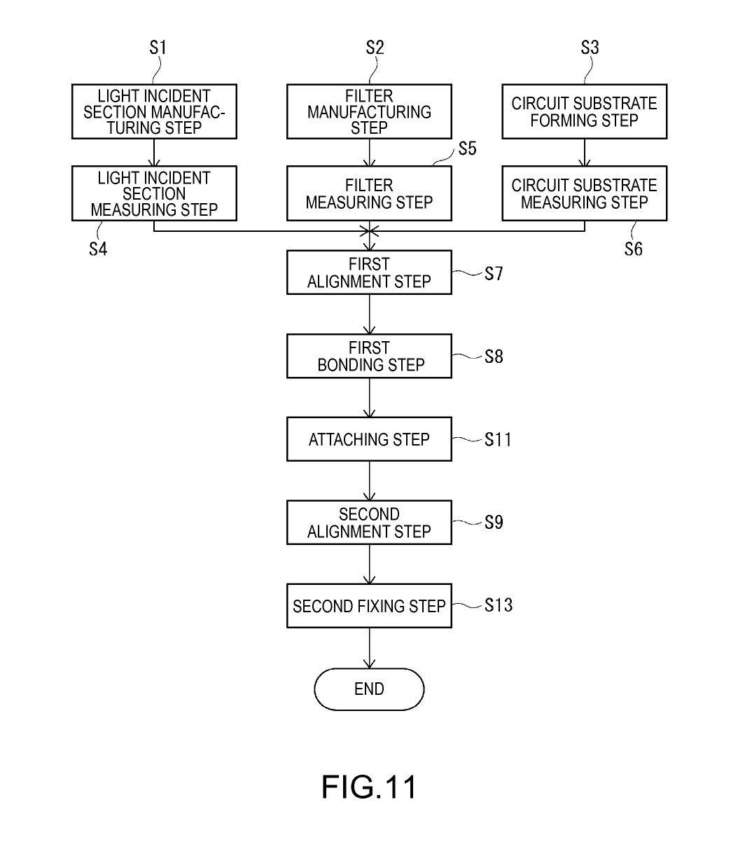

In contrast, the light incident section 121 may be fixed to the enclosure 11 by using fixing holes 11T2 provided therein, as shown in FIGS. 10 and 11.

FIG. 10 describes an alignment adjustment method in a second variation of the first embodiment. FIG. 11 is a flowchart showing the alignment adjustment method in the present variation.

In this case, steps S1 to S6 are carried out, as in the first embodiment. Thereafter, the first alignment step S7 and the first bonding step S8 are carried out, in which the alignment marks 5M and 124M and the second and third adjustment amounts are used to adjust the alignment between the wavelength tunable interference filter 5 and the circuit substrate 124, followed by bonding of the wavelength tunable interference filter 5 and the circuit substrate 124 to each other, as in the first embodiment.

The attaching step S11 is then carried out, in which the circuit substrate 124 is fixed to the enclosure 11 by using the fixing holes 124T1 in the circuit substrate 124 and fixing holes 11T1 in the enclosure 11, as shown in FIG. 11.

The second alignment step S9 is then carried out, in which the alignment marks 5M and 121M and the first and second adjustment amounts are used to adjust the alignment between the wavelength tunable interference filter 5 and the light incident section 121, as in the first embodiment.

Thereafter, in the present variation, the light incident section 121 is fixed to the enclosure 11 by using the fixing holes 121T in the light incident section 121 and the fixing holes 11T2 in the enclosure 11 (second fixing step S13).

Using the method described above also allows the ideal center points of the telecentric optical system that forms the incident angle limiter in the light incident section 121, the wavelength tunable interference filter 5, and the imaging device 123 to be aligned with each other along a single axis after the first alignment step S7 and the second alignment step S9 are carried out, whereby a high-precision spectroscopic image can be acquired.

In the second variation, instead of carrying out the first alignment step S7 and the first bonding step S8, the second alignment step S9 and the second bonding step S12 may be carried out, in which the wavelength tunable interference filter 5 and the light incident section 121 are bonded to each other, as in the first variation.

In this case, the second bonding step S12 is followed by the attaching step S11. The first alignment step S7 is then carried out, in which the alignment between the wavelength tunable interference filter 5 and the circuit substrate 124 is adjusted, and then the second fixing step S13 is carried out, in which the light incident section 121 is fixed to the enclosure 11.

### Third Variation of First Embodiment

In the first embodiment, the first variation, and the second variation described above, the light incident section 121 is fixed to the circuit substrate 124 or the enclosure 11 by using the fixing holes 121T in the light incident section 121 and the fixing holes 124T1 in the circuit substrate 124 or the fixing holes 11T2 in the enclosure 11 with the aid of screws or any other fasteners but the fixing procedure described above is not necessarily employed.

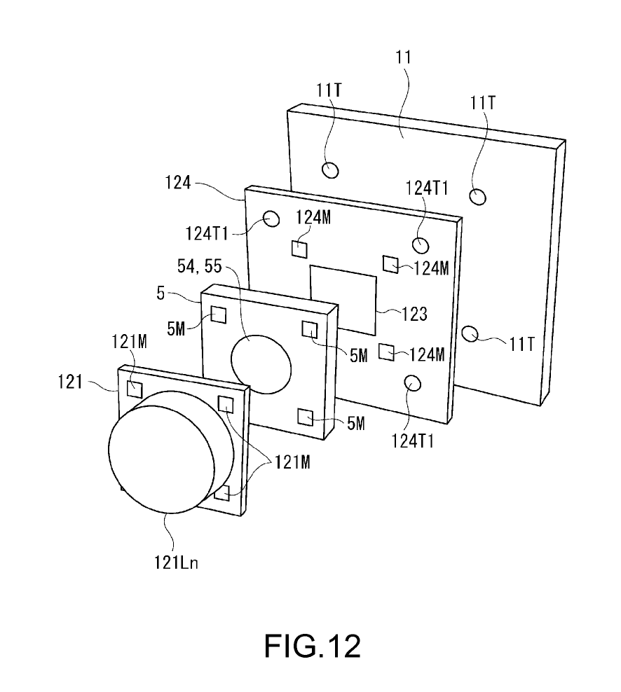

FIG. 12 describes an alignment adjustment method in a third variation of the first embodiment.

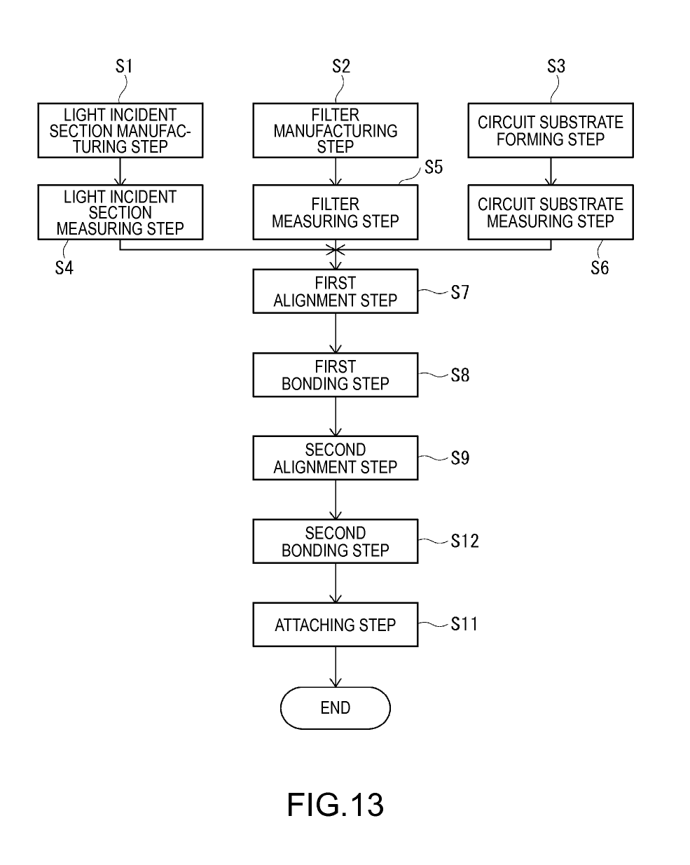

FIG. 13 is a flowchart of the alignment adjustment method in the third variation of the first embodiment.

In the present variation, the wavelength tunable interference filter 5 and the circuit substrate 124 are bonded to each other, for example, with an adhesive, and so are the wavelength tunable interference filter 5 and the light incident section 121, as shown in FIG. 12.

In this case, steps S1 to S6 are first carried out as shown in FIG. 13, as in the first embodiment.

The first alignment step S7 and the first bonding step S8 are then carried out, in which the wavelength tunable interference filter 5 and the circuit substrate 124 undergo the alignment adjustment and are then bonded to each other, as in the first embodiment.

The second alignment step S9 is then carried out, in which the alignment between the wavelength tunable interference filter 5 and the light incident section 121 is adjusted.

The second bonding step S12 in the first variation is then carried out, in which the light incident section 121 and the wavelength tunable interference filter 5 are bonded to each other.

The attaching step S11 is then carried out, in which the circuit substrate 124 is fixed to the enclosure 11.

In FIG. 13, the first alignment step S7, the first bonding step S8, the second alignment step S9, the second bonding step S12, and the attaching step S11 are carried out in this order by way of example, but the above procedure is not necessarily employed.

For example, the second alignment step S9, the second bonding step S12, the first alignment step S7, the first bonding step S8, and the attaching step S11 may be carried out in this order.

Instead, after the attaching step S11 is carried out, in which the circuit substrate 124 is fixed to the enclosure 11, the first alignment step S7, the first bonding step S8, the second alignment step S9, and the second bonding step S12 may be carried out in this order. Still instead, after the attaching step S11 is carried out, the second alignment step S9, the second bonding step S12, the first alignment step S7, and the first bonding step S8 may be carried out in this order.

Still further instead, after the first alignment step S7 and the first bonding step S8 are carried out, the attaching step S11 may be carried out followed by the second alignment step S9 and the second bonding step S12. Still further instead, after the second alignment step S9 and the second bonding step S12 are carried out, the attaching step S11 may be carried out followed by the first alignment step S7 and the first bonding step S8.

### Second Embodiment

The above first embodiment has been described with reference to the alignment adjustment method performed on the assumption that the optical axis of the light incident section 121 is parallel to the optical axis of the wavelength tunable interference filter 5 and the spectroscopic camera 10 the components of which are assembled based on the thus performed alignment adjustment method. A second embodiment differs from the first embodiment described above in that the optical axis of the light incident section 121 and the optical axis of the wavelength tunable interference filter 5 can be made parallel to each other even when they are initially not parallel to each other.

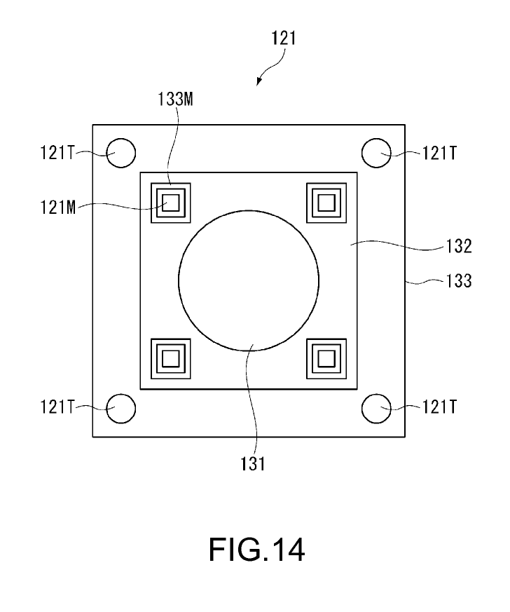

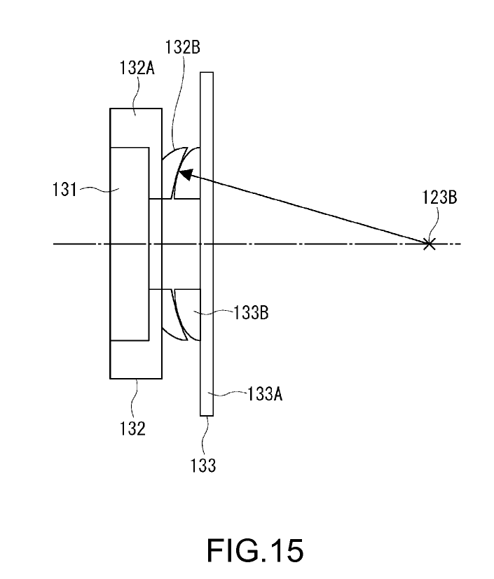

FIG. 14 is a plan view schematically showing a light incident section in the second embodiment. FIG. 15 is a side view schematically showing a structure that attaches the light incident section.

In the present embodiment, the light incident section 121 includes a first mount 132, which holds an incident angle limiter 131, and a second mount 133, which holds the first mount 132, as shown in FIGS. 14 and 15.

The incident angle limiter 131 is, for example, a lens group formed of the plurality of lenses 121Ln, which form the telecentric optical system. The incident angle limiter 131 may instead be a viewing angle limiting member, for example, an LCF, as described above.

The first mount 132 includes a holding frame 132A and a first engaging portion 132B, which is provided on a surface facing the second mount 133, as shown in FIG. 15.

The holding frame 132A is a frame member that holds the incident angle limiter 131. The holding frame 132A is provided with first alignment marks 121M, which indicate the mechanical center point of the incident angle limiter 131 held by the holding frame 132A.

The first engaging portion 132B has a recessed, spherical shape that is concave toward the second mount 133. The center of curvature of the spherical surface of the first engaging portion 132B coincides with the ideal center point 123B of the imaging device 123. A light passage hole through which light having passed through the incident angle limiter 131 passes is provided in the first engaging portion 132B, specifically, a central portion thereof facing the incident angle limiter 131.

The second mount 133 includes a fixing portion 133A and a second engaging portion 133B, which is provided on a surface facing the first mount 132.

The fixing portion 133A has the fixing holes 121T and is fixed, for example, to the circuit substrate 124 with the aid of the fixing holes 121T in the fixing portion 133A and the fixing holes 124T1 in the circuit substrate 124. The fixing portion 133A may instead be fixed to the enclosure 11 with the aid of the fixing holes 121T in the fixing portion 133A and the fixing holes 11T2 in the enclosure 11, as shown in the second variation.

The second engaging portion 133B has a protruding, spherical shape that is convex toward the first mount 132. The center of curvature of the spherical surface of the second engaging portion 133B coincides with the ideal center point 123B of the imaging device 123, as in the case of the first engaging portion 132B.

A light passage hole through which light having passed through the incident angle limiter 131 passes is provided in the second engaging portion 133B, specifically, a central portion thereof facing the incident angle limiter 131.

### Optical Axis Adjustment Method

In the present embodiment, steps S1 to S8 are carried out, in which the wavelength tunable interference filter 5 is bonded to the circuit substrate 124 (imaging device 123), as in the first embodiment described above.

Thereafter, in the second alignment step S9, the alignment between the wavelength tunable interference filter 5 and the light incident section 121 is adjusted, and the first alignment marks 121M provided on the first mount 132 and alignment marks 133M provided on the second mount 133 are brought into coincidence with each other for adjustment of alignment between the first mount 132 and the second mount 133, as shown in FIG. 14.

In this process, the incident angle limiter 131 is held by the first mount 132 in advance, and in this state, an inclination angle of the incident angle limiter 131 with respect to the direction of the frame plane of the holding frame 132A is measured.

Alignment between the first mount 132 and the second mount 133 is then so adjusted that the recessed spherical surface of the first engaging portion 132B comes into contact with the protruding spherical surface of the second engaging portion 133B and the optical axis of the incident angle limiter 131 becomes perpendicular to the fixing portion 133A of the second mount 133. The first mount 132 is then fixed to the second mount 133.

The alignment between the light incident section 121 (incident angle limiter 131) and the wavelength tunable interference filter 5 is then adjusted, as in the first embodiment, and the second mount 133 is fixed to the wavelength tunable interference filter 5.

### Advantageous Effect of Second Embodiment

In the present embodiment, the first mount 132, which holds the incident angle limiter 131, is provided with the first engaging portion 132B having a recessed spherical shape, and the second engaging portion 133B having a protruding spherical shape that can engage with the first engaging portion 132B is so provided that the second engaging portion 133B faces the first mount 132. The second alignment step S9 is so carried out that the centers of curvature of the engaging portions 132B and 133B coincide with the ideal center point 123B of the imaging device 123. Therefore, adjusting the positions of the first engaging portion 132B and the second engaging portion 133B relative to each other in such away that the optical axis of the incident angle limiter 131 held by the first mount 132 is perpendicular to the fixing portion 133A of the second mount 133 allows the inclination angle to be so adjusted that light incident through the ideal center point 121B of the incident angle limiter 131 is focused at the ideal center point 123B of the imaging device 123. Therefore, in the present embodiment, in which the light incident section 121 has a configuration that allows adjustment of the inclination angle of the optical axis of incident light, a decrease in precision of a spectroscopic image due to a shift in the angle of incidence of the incident light can be suppressed.

### Other Embodiments

The invention is not limited to the embodiments described above, and variations, improvements, and other modifications fall within the scope of the invention to the extent that they can achieve the advantage of the invention.

For example, in the embodiments described above, the spectroscopic camera 10 is presented by way of example. In addition, a composition analyzer and other apparatus including the spectroscopic camera 10 described above can be provided.

In the embodiments described above, the lenses 121Ln, which form the telecentric optical system, are presented as the incident angle limiter by way of example, but the incident angle limiter is not limited thereto. For example, a viewing angle limiting film (viewing angle limiting plate) that transmits light incident at an angle smaller than or equal to a predetermined angle of incidence whereas blocking light incident at an angle greater than the predetermined angle of incidence, such as an LCF, may be used as the incident angle limiter. In this case, alignment marks indicating the mechanical center point of the viewing angle limiting film are provided, and the amount of deviation of the mechanical center point of the viewing angle limiting film from the ideal center point thereof and the angle of rotation indicating the deviation direction are measured in advance for adjustment of the alignment between the viewing angle limiting film and the wavelength tunable interference filter 5.

Further, in the embodiments described above, the alignment between the wavelength tunable interference filter 5 and the imaging device 123 is adjusted on the assumption that the imaging device 123 is mounted on the circuit substrate 124 byway of example, but the imaging device 123 is not necessarily mounted on the circuit substrate 124. Alignment marks provided on the imaging device 123 and the second alignment marks 5M provided on the wavelength tunable interference filter 5 may be used to perform the adjustment of the alignment therebetween on the assumption that the imaging device 123 is not mounted on the circuit substrate 124, followed by bonding of the wavelength tunable interference filter 5 and the imaging device 123 to each other. In this case, the imaging device 123 with the wavelength tunable interference filter 5 bonded thereto may be mounted on the circuit substrate 124.

In each of the embodiments described above, the wavelength tunable interference filter 5 may, for example, be accommodated in an enclosure and then incorporated in the spectroscopic camera 10. In this case, alignment marks may be provided on the enclosure. Further, the enclosure may be sealed and maintained under vacuum so that the electrostatic actuator 56 in the wavelength tunable interference filter 5 shows improved drive response to voltage application.

In the embodiments described above, the second alignment marks 5M, the first alignment marks 121M, the second adjustment amount, and the first adjustment amount are used to adjust the alignment between the wavelength tunable interference filter 5 and the light incident section 121, and the second alignment marks 5M, the third alignment marks 124M, the second adjustment amount, and the third adjustment amount are used to adjust the alignment between the wavelength tunable interference filter 5 and the imaging device 123. That is, the alignment between the light incident section 121 and the imaging device 123 is adjusted with respect to the wavelength tunable interference filter 5. In contrast, the light incident section 121 or the imaging device 123 may be used as the reference, and the alignment between the other components may be adjusted.

For example, the first alignment marks 121M, the second alignment marks 5M, the first adjustment amount, and the second adjustment amount may be used to adjust the alignment between the light incident section 121 and the wavelength tunable interference filter 5, and the first alignment marks 121M, the third alignment marks 124M, the first adjustment amount, and the third adjustment amount may be used to adjust the alignment between the light incident section 121 and the imaging device 123. Adjusting the alignment between the wavelength tunable interference filter 5 and the imaging device 123 with respect to the light incident section 121 as described above also allows the first ideal central axis passing through the ideal center point 121B of the telecentric optical system in the light incident section 121, the second ideal central axis passing through the ideal center point 5B of the wavelength tunable interference filter 5, and the third ideal central axis passing through the ideal center point 123B of the imaging device 123 to coincide with one another, as in each of the embodiments described above.

Similarly, the third alignment marks 124M, the second alignment marks 5M, the third adjustment amount, and the second adjustment amount may be used to adjust the alignment between the imaging device 123 and the wavelength tunable interference filter 5, and the third alignment marks 124M, the first alignment marks 121M, the third adjustment amount, and the first adjustment amount may be used to adjust the alignment between the imaging device 123 and the light incident section 121. Adjusting the alignment between the wavelength tunable interference filter 5 and the light incident section 121 with respect to the imaging device 123 as described above also allows the first ideal central axis passing through the ideal center point 121B of the telecentric optical system in the light incident section 121, the second ideal central axis passing through the ideal center point 5B of the wavelength tunable interference filter 5, and the third ideal central axis passing through the ideal center point 123B of the imaging device 123 to coincide with one another, as in each of the embodiments described above.

In the first embodiment described above, the alignment adjustment is so performed with respect to the wavelength tunable interference filter 5 that each of the ideal central axes of the light incident section 121 and the imaging device 123 coincides with the second ideal central axis of the wavelength tunable interference filter 5. In addition, the alignment between the light incident section 121 and the imaging device 123 may further be adjusted. That is, the following three types of alignment adjustment may be performed: adjustment of the alignment between the light incident section 121 and the wavelength tunable interference filter 5 by using the alignment marks 121M and 5M, the first adjustment amount, and the second adjustment amount; adjustment of the alignment between the wavelength tunable interference filter 5 and the imaging device 123 by using the alignment marks 5M and 124M, the second adjustment amount, and the third adjustment amount; and adjustment of the alignment between the light incident section 121 and the imaging device 123 by using the alignment marks 121M and 124M, the first adjustment amount, and the third adjustment amount. In this case, the first ideal central axis, the second ideal central axis, and the third ideal central axis are brought into coincidence with one another with higher precision.

In the embodiments described above, the alignment marks 121M, 5M, and 124M are marks indicating the mechanical central axes passing through the mechanical center points 121A, 5A, and 123A of the light incident section 121, the wavelength tunable interference filter 5, and the imaging device 123, respectively, but the alignment marks are not necessarily set this way.

For example, the first alignment marks 121M may be marks indicating a predetermined first axis (axis parallel to optical axis) different from the mechanical central axis of the light incident section 121. In this case, in the light incident section measuring step S4, the amount of deviation of the first axis from the first ideal central axis and the angle of rotation indicating the deviation direction may be measured as the first adjustment amount.

Similarly, the second alignment marks 5M may be marks indicating a predetermined second axis different from the mechanical central axis of the wavelength tunable interference filter 5. In this case, in the filter measuring step S5, the amount of deviation of the second axis from the second ideal central axis and the angle of rotation indicating the deviation direction may be measured as the second adjustment amount.

Similarly, the third alignment marks 124M may be marks indicating a predetermined third axis (axis parallel to optical axis) different from the mechanical central axis of the imaging device 123. In this case, in the circuit substrate measuring step S6, the amount of deviation of the third axis from the third ideal central axis and the angle of rotation indicating the deviation direction may be measured as the third adjustment amount.

In each of the embodiments described above, the wavelength tunable interference filter 5 includes the electrostatic actuator 56, which applies a voltage to change the dimension of the gap between the reflection films 54 and 55, but the wavelength tunable interference filter 5 is not necessarily configured this way.

For example, the wavelength tunable interference filter 5 may use a induction actuator having a first induction coil provided in place of the fixed electrode 561 and a second induction coil or a permanent magnet provided in place of the movable electrode 562.

Further, the electrostatic actuator 56 may be replaced with a piezoelectric actuator. In this case, for example, a lower electrode layer, a piezoelectric film, and an upper electrode layer are layered on each other and disposed at the holding portion 522, and a voltage applied between the lower electrode layer and the upper electrode layer is changed as an input value to expand or contract the piezoelectric film so as to bend the holding portion 522.

Each of the embodiments described above shows the case where the wavelength tunable interference filter 5 is configured as a Fabry-Perot etalon and includes the fixed substrate 51 and the movable substrate 52 so bonded to each other that they face each other with the fixed reflection film 54 provided on the fixed substrate 51 and the movable reflection film 55 provided on the movable substrate 52, but the configuration of the wavelength tunable interference filter 5 is not limited thereto.

For example, the wavelength tunable interference filter 5 may be so configured that the fixed substrate 51 and the movable substrate 52 are not bonded to each other but a gap changer that changes the inter-reflection-film gap, such as a piezoelectric device, is provided between the substrates.

Further, the wavelength tunable interference filter 5 is not necessarily formed of two substrates. For example, a wavelength tunable interference filter having the following configuration may be used: Two reflection films are layered on a single substrate with a sacrifice layer between the reflection films; and the sacrifice layer is etched away or otherwise removed to form a gap.

Moreover, as the spectroscopic device, an AOTF (acousto-optic tunable filter), an LCTF (liquid crystal tunable filter), or any other tunable filter may be used. In this case, however, size reduction of the spectroscopic camera 10 is likely to be difficult. It is therefore preferable to use a Fabry-Perot etalon.

Further, in each of the embodiments described above, the wavelength tunable interference filter 5 that can change the wavelength of transmitted light by changing the gap G1 between the reflection films 54 and 55 is presented by way of example, but a wavelength tunable interference filter is not necessarily used. For example, a wavelength-fixed interference filter (Fabry-Perot etalon) may be used.

In addition, the specific structure in any of the embodiments of the invention can be changed as appropriate in actual implementation of the invention to any other structure to the extent that the advantage of the invention is achieved.

The entire disclosure of Japanese Patent Application No. 2013-061547, filed Mar. 25, 2013 is expressly incorporated by reference herein.

What is claimed is:

1. A spectroscopic camera comprising:
a spectroscopic device that selects light of a predetermined wavelength from incident light and transmits the selected light; and
an incident angle limiter that limits the angle of incidence of the incident light incident on the spectroscopic device to a value smaller than or equal to a predetermined angle,
wherein the incident angle limiter has a first alignment mark indicating a mechanical central axis of the incident angle limiter and a first ideal central axis where the angle of incidence of the incident light is limited to a predetermined ideal angle,
the spectroscopic device has a second alignment mark indicating a mechanical central axis of the spectroscopic device and a second ideal central axis where light of a wavelength at the center of a transmission wavelength region is transmitted, and
The first ideal central axis in the incident angle limiter coincides with the second ideal central axis in the spectroscopic device.

2. The spectroscopic camera according to claim 1, further comprising:
an imaging device that receives light having passed through the spectroscopic device,
wherein the imaging device has a third alignment mark indicating a mechanical central axis of the imaging device and a third ideal central axis where incident light is received by the imaging device at predetermined ideal sensitivity,
The third ideal central axis in the imaging device coincides with the second ideal central axis in the spectroscopic device.

3. The spectroscopic camera according to claim 1,
wherein the spectroscopic device includes a first reflection film that reflects part of incident light and transmits at least part of the incident light,
a second reflection film that faces the first reflection film, reflects part of incident light, and transmits at least part of the incident light, and
a gap changer that changes the dimension of a gap between the first reflection film and the second reflection film.

4. The spectroscopic camera according to claim 2,
wherein the spectroscopic device includes
a first reflection film that reflects part of incident light and transmits at least part of the incident light,
a second reflection film that faces the first reflection film, reflects part of incident light, and transmits at least part of the incident light, and
a gap changer that changes the dimension of a gap between the first reflection film and the second reflection film.

5. The spectroscopic camera according to claim 2, further comprising:
a first mount that holds the incident angle limiter and a second mount to which the first mount is fixed,
wherein the first mount is provided with a first engaging portion having a recessed spherical surface,
the second mount is provided with a second engaging portion having a protruding spherical surface that comes into contact with the recessed spherical surface of the first engaging portion, and
the centers of curvature of the protruding spherical surface and the recessed spherical surface coincide with an intersection point of the imaging device and the third ideal central axis.

6. An alignment adjustment method for adjusting alignment of a spectroscopic device that selects light of a predetermined wavelength from incident light and transmits the selected light, an incident angle limiter that limits the angle of incidence of the incident light incident on the spectroscopic device to a value smaller than or equal to a predetermined angle, and an imaging device that receives light having passed through the spectroscopic device in a spectroscopic camera including the spectroscopic device, the incident angle limiter and the imaging device,
the incident angle limiter having a first alignment mark indicating a mechanical central axis of the incident angle limiter,
the spectroscopic device having a second alignment mark indicating a mechanical central axis of the spectroscopic device,
the imaging device having a third alignment mark indicating a mechanical central axis of the imaging device,
the alignment adjustment method comprising:
measuring a first adjustment amount that is a combination of the amount of deviation of the mechanical central axis of the incident angle limiter from a first ideal central axis indicating a position and a rotational angle where the angle of incidence of the incident light is limited to an ideal angle in the incident angle limiter;
measuring a second adjustment amount that is a combination of the amount of deviation of the mechanical central axis of the spectroscopic device from a second ideal central axis indicating a position and a rotational angle where light of a central wavelength out of light that the spectroscopic device transmits is transmitted;
measuring a third adjustment amount that is a combination of the amount of deviation of the mechanical central axis of the imaging device from a third ideal central axis indicating a position and a rotational angle where incident light is received by the imaging device at predetermined set sensitivity;
adjusting the positions of the first alignment mark and the second alignment mark relative to each other in accordance with the first adjustment amount and the second adjustment amount in such a way that the first ideal central axis and the second ideal central axis coincide with each other; and
adjusting the positions of the second alignment mark and the third alignment mark relative to each other in accordance with the second adjustment amount and the third adjustment amount in such a way that the second ideal central axis and the third ideal central axis coincide with each other.

7. The alignment adjustment method according to claim 6, further comprising:
adjusting the positions of the first alignment mark and the third alignment mark relative to each other in accordance with the first adjustment amount and the third adjustment amount in such a way that the first ideal central axis and the third ideal central axis coincide with each other.

8. A spectroscopic camera comprising:
a spectroscopic device that selects light of a predetermined wavelength from incident light and transmits the selected light;
an incident angle limiter that limits the angle of incidence of the incident light incident on the spectroscopic device to a value smaller than or equal to a predetermined angle; and
an imaging device that receives light having passed through the spectroscopic device,
wherein the incident angle limiter has a first alignment mark that defines the positional relationship between the incident angle limiter and a first ideal central axis passing through a position where the angle of incidence of the incident light is limited to a predetermined ideal angle in the incident angle limiter, and the positional relationship between the first ideal central axis and the incident angle limiter varies from one incident angle limiter to another,
the spectroscopic device has a second alignment mark that defines the positional relationship between the spectroscopic device and a second ideal central axis passing through a position where light of a wavelength at the center of a transmission wavelength region in the spectroscopic device is transmitted, and the positional relationship between the second ideal central axis and the spectroscopic device varies from one spectroscopic device to another,
the imaging device has a third alignment mark that defines the relative positional relationship between the imaging device and a third ideal central axis passing through a position where incident light is received by the imaging device at predetermined ideal sensitivity, and the positional relationship between the third ideal central axis and the imaging device varies from one imaging device to another, and
the first ideal central axis, the second ideal central axis, and the third ideal central axis coincide with each other.
